(19) United States
(12) Patent Application Publication
(10) Pub. No.: US 2018/0122007 A1
(43) Pub. Date: May 3, 2018

(54) IN-CASH FOREIGN CURRENCY TRADING SYSTEM

(71) Applicant: Guilherme Mendes Franco, Bolo Horizonte (BR)

(72) Inventor: Guilherme Mendes Franco, Bolo Horizonte (BR)

(21) Appl. No.: 15/341,074

(22) Filed: Nov. 2, 2016

(51) Int. Cl. G06Q 40/04

(52) U.S. Cl. CPC G06Q 40/04

(57) ABSTRACT

The in-cash foreign currency trading system, object of this invention, basically consists of software that operates a virtual environment was developed to bring all participants together in the in-cash foreign currency market such as end buyers, end sellers, exchange currency representatives, and the offices of the Financial Institution (FI), (which is behind the system), and other financial institutions operating in the foreign exchange market, making it possible for participants to have the freedom to practice their offers, unlike the current model being used in the market.

This new virtual environment organizes similar offerings and allows the closing of only the best offers in each segment. The conditions cannot be changed after closing the deal on the platform, thereby protecting the participants against future currency fluctuations or from one of the party's backing out.

This system automates and carries out the necessary operations, organizes similar offerings and breaks them down by type of currency and delivery method, centralizing all participants' offers, including end-clients. It also organizes similar offerings so that only the best deals in each segment can be closed.

The conditions cannot be changed after closing the deal on the platform, thereby protecting the participants against future currency fluctuations or from one of the party's backing out, allowing the parties to close deals between themselves.

In short, the System's software manager has four modules: General Registrations, Individual Registration and Parameters, Corporate Registration and Parameters, and Negotiations Module as well as custody, financial, general, security, monitoring, and routines and integration modules.

### FIELD OF OPERATION

Finance market;
Currency Exchange market;
Control and audit of exchange currency representatives

### KNOWN STATE OF THE ART

Currently, in most countries, in order to buy or sell in-cash foreign currency, the end-client must find a participant in the foreign exchange market that is authorized to operate by the Regulator or another similar institution that regulates the foreign exchange market in the country. In Brazil, for example, the regulator is the Central Bank of Brazil (BACEN), whereas in the United States, the Federal Reserve (FED) is the regulator.

For instance, in Brazil, the participant is the so-called Financial Institution, and its outsourced representatives are known as Exchange Currency Representatives.

In countries with a strong currency, it is not very common for people to exchange currency before traveling. However, in developing countries, this service is widely used and provided by the financial institutions or their outsourced representatives.

It happens that, in these countries, the financial institutions have a considerable number of outsourced representatives. These outsourced service providers will be called Exchange Currency Representatives. Financial institutions authorized by the regulator to negotiate the currency exchange shall monitor and audit their Exchange Currency Representatives so as to ensure the transaction's legality and prevent money laundering attempts.

However, due to the large number of representatives, control is extremely flawed and thus aids and abets money laundering or a significant amount of tax evasion, since, arguably, the representatives or smaller institutions do not have sufficient controls or checking tools.

In the current model, each participant, which may be the financial institution itself or one of its exchange currency representatives, sets the selling price. Each has its own method of how to check the client's identity documents in order to receive or pay the end-client for transactions in foreign currency.

The heterogeneity of client identification methods and the origin of funds to set the price to be charged by the specialized company result in an excess amount of work because the company has to make quotations with various specialized institutions to stipulate the price of the currency that the end-client wants to purchase. Usually, the end-client is very insecure because he never knows if he is, indeed, making a transaction at the right price.

Another point worth noting is that, currently, there is an excess in the fees being charged. This is called the ‘spread’, which is charged mainly because of logistics costs, money inventory shipping, and high profit margins to deal with the compliance risk involved in the current model, especially when the local currency is not strong, as is the U.S. dollar, euro, and British pound.

Buyers usually pay a premium of approximately 4.5% on the exchange rate of each type of foreign currency, while the seller receives a discount of approximately 4% to sell foreign currency in countries like Brazil, i.e., change reais for dollars. Therefore, it happens that most potential foreign currency sellers keep leftover foreign currency on hand after people return from an overseas trip because there is no chance of selling these currencies without a forward discount of about 8.5% (a 4% forward premium on the purchase and a 4.5% forward discount on the sale).

Since the discount percentage on the sale is very high, few end-clients sell the foreign currency they have, preferring to hold onto it. As a result, for each new currency purchase made by an end-client, financial intuitions need to import and distribute the paper currency, raising the final cost of the foreign currency Currently, towns with few inhabitants do not have specialized companies that operate with in-cash foreign currency due to the logistics cost, money inventory shipping, and investment in security.

Recently, computer apps called exchange rate seekers' have appeared on the market that are used to connect sellers and end buyers. Seekers inform the end client as to the prices financial institutions and specialized companies are offering. However, these offers are only references and may fluctuate between the search date and the closing of the transaction. Moreover, there is no indication of the type of delivery, leading to unfair competition between participants. According to the standards set by most country regulatory agencies—in Brazil, BACEN—the apps that connect the seller with the final buyer without the intermediation of an agent authorized by the regulator to operate in the foreign exchange market are illegal. The apps neither check client registration data nor require documentation and, therefore, put the client's security at risk, luring him into theft or handing him counterfeit paper currency. Furthermore, it is highly conducive to a money laundering environment.

### Innovations Introduced in the State of the Art

The In-Cash Foreign Currency Trade System, object of this invention, is an innovation, a new method to be applied to the trading of foreign currency.

A virtual environment was developed to bring all participants together in the in-cash foreign currency market such as end buyers, end sellers, exchange currency representatives, and the offices of the Financial Institution (FI), (which is behind the system), and other financial institutions operating in the foreign exchange market, making it possible for participants to have the freedom to practice their offers, unlike the current model being used in the market.

Environment protected from market fluctuations.

This new virtual environment organizes similar offerings and allows the closing of only the best offers in each segment within the region chosen by the client. The conditions cannot be changed after closing the deal on the platform, thereby protecting the participants against future currency fluctuations or from one of the party's backing out.

To ensure that the participants will comply with deals closed in the system, said participants should send funds in national currency or guarantees, i.e., provide their credit card numbers for pre-authorization of the charge, to the drawing account of the FI (which is behind the system). For sellers, in addition to guarantees or funds in national currency, they may deposit the foreign currency, object of the sale, at the offices of the FI, which is behind the system, or deliver the foreign currency to the Exchange Currency Representative.

In addition to the electronic platform, it features the ability to carry out foreign exchange transactions, with a financial institution behind the system that is authorized by the regulator, i.e., the authority responsible for exchange control. Thus, the FI participates as a counterparty in all transactions, collecting and validating the required information and informing the regulator of all completed transactions, thus enabling all participants to negotiate freely, including buyers and sellers—end-clients. Given that the FI will not control the price of the end-client's offer and those of the other participants in the foreign exchange market, the spread for the end-client should be drastically reduced, since everyone involved may close transactions between themselves.

If there is a match in the offer prices, the FI will act, buying from the seller and reselling to the buyer the amount he wanted so as to meet his demand.

This new system also substantially reduces the logistics costs and foreign currency inventory and further reduces the risk of exchange rate fluctuation, because the system considers the transaction as being completed at the time the conditions were laid out so as to close the deal. This is because the resources, i.e., foreign currency or financial guarantees for the seller, and national currency or financial guarantees for the buyer, shall be deposited by the clients in the FI or with its representatives (i.e., exchange currency representatives in Brazil) before they can make the offer.

For a perfect understanding of the object of this patent, some figures are attached:

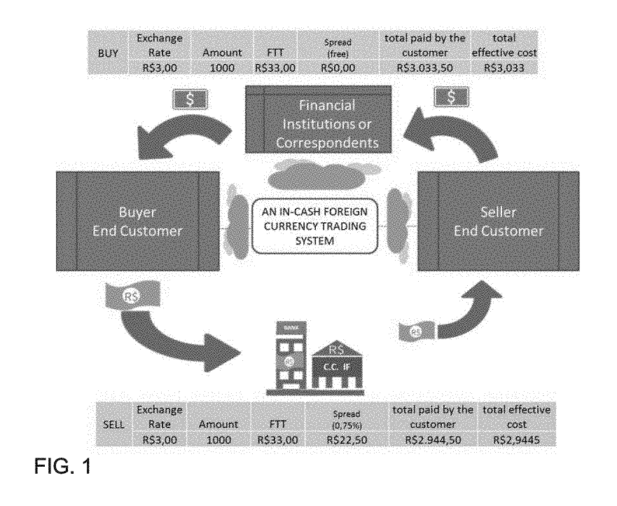

FIG. 1 illustrates the flow of the Seller's foreign currency and Buyer's national Currency at the time of the transaction.

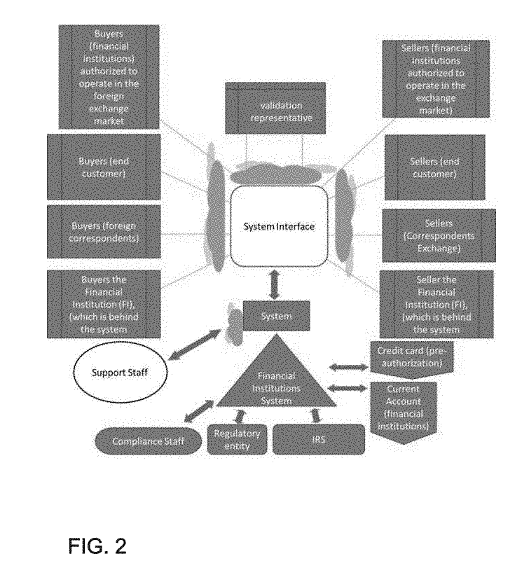

FIG. 2 illustrates all participants who will work in the system.

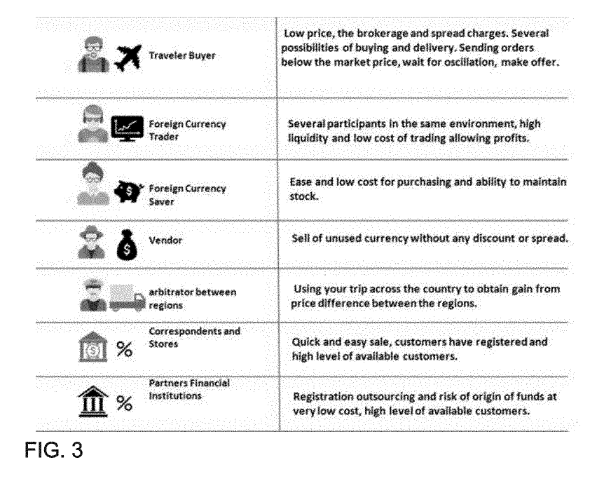

FIG. 3 illustrates the benefit of the system for all participants.

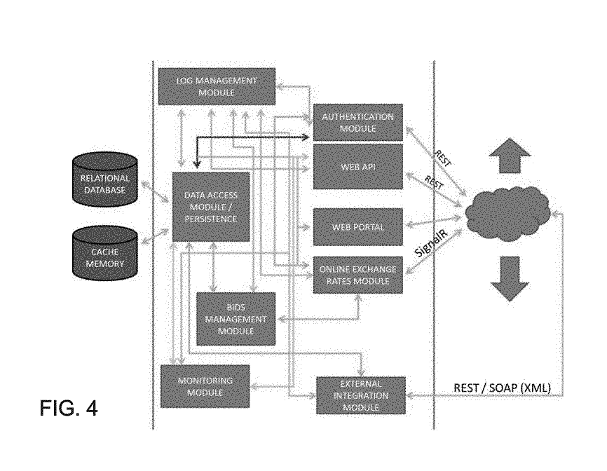

FIG. 4 illustrates the system architecture and the platform created for trading foreign currencies.

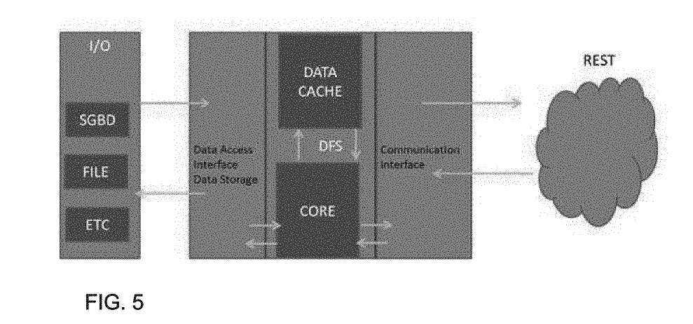

FIGS. 5 (A, B and C) illustrate the possibility of the selling client to register the series of each note he intends to offer as well as its state of conservation Thus, as illustrated in FIG. 1, the end-client negotiates the currency at a much lower cost than is currently practiced.

The FIG. 1 also informs that:
WEB PORTAL: Portal that will allow the customers to trade currencies.
WEB API: API that will supply the system applications with all the methods needed to perform their tasks. All tasks that do not require a continuous data stream (persistent connection) will be performed by this system module;
AUTHENTICATION MODULE: System module that is responsible for authenticating users who want to log into applications. This module will respond to the WEB API and ONLINE EXCHANGE RATES MODULE (BOOK);
ONLINE EXCHANGE RATES MODULE (BOOK): This module will be responsible for providing all BOOK DEALS in real-time for the users. All other functions that must be provided in real time to users will be developed in this module.
BIDS MANAGEMENT MODULE: This module will be responsible for managing the buy and sell bids (will match the bids). This module will communicate with the WEB API and the ONLINE EXCHANGE RATES MODULE (BOOK);
MONITORING MODULE: This module will be responsible for monitoring system activity. Eg registration monitoring, PLD and compliance monitoring, database access monitoring, etc;
LOG MANAGEMENT MODULE: This system module will be responsible for management of all the application logs—both writing and reading;
DATA ACCESS MODULE/PERSISTENCE: This module is responsible for the persistence of data applications in the database;
RELATIONAL DATABASE: A database that will store all data generated by the system applications. A “free” database software can be used for this purpose, such as PostgreSQL for example, for its robustness and scalability;
   CACHE MEMORY: non-relational database that will store “memory state” data of some data applications that cannot be lost if there is an unavailability of it. The suggestion is to use a non-relational database object-oriented, for eg: Mongo Db or Db-4objects due to its high performance;

One of the main purposes of this system is to create the possibility of including all participants, making the closing trading price fairer, thereby avoiding price distortion in relation to the offers and similar locations as seen in FIG. 2.

To attract all the participants, the system, object of this invention, has added value for each of them, in such a way as to benefit the entire market.

FIG. 3 illustrates the aggregated value to which each one is entitled

The system for Sparsely Populated Regions

The “arbitrator between regions” participant plays an important role in the development of the in-cash foreign exchange market. Aware that the purchase price is higher in low population density regions because the supply is scarce, he buys foreign currency at large centers and resells them in sparsely populated municipalities and that way makes a profit. This operation supplies the local demand and can be carried out whenever there are validation representatives or validators, because this is how it will be handled in Brazil, with the location used only as an example.

### Validation Representatives

The validation representative is the agent of a financial institution authorized to operate in the exchange market, acting as an intermediary, and whose main function is to get the parties to close deals on the platform, confirm that the paper currency is authentic, and that it complies with the seller's declarations, then passing it on to the buyer. If there is any disagreement, the Validator Representative may act as moderator so as to renegotiate the values of different paper currency. By not having money inventory, costs involving shipping, security, and logistics are irrelevant, enabling the currency to be available in less populated towns.

In addition to the benefits for the participants and end-clients, this system greatly contributes to the fight against money laundering in this country, satisfying one of the pillars of the regulator (BACEN, in the case of Brazil). By centralizing and computerizing both the registration and receipt of funds and inclusion of the offers, this system changes the level of controls, thus thwarting any attempt at money laundering and tax evasion.

To better understand the current scenario, its problems, and the innovation proposed by the In-Cash Foreign Currency Exchange Trading System, object of this invention, the table below illustrates the scenario in which trading occurs, the current problems, and proposed solution.

| Current model | | |
|---|---|---|
| Current | | Innovation |
| Scenario | Current Problem | Proposed Solution |
| Inability to | The client looks for a | The system created the |
| regulate an | participant to make the | validation representative as an |
| end-client | purchase and sale and | intermediary in the transaction, |
| buying from | this generates a spread | buying from the seller and |
| another end- | for the participant | reselling to the buyer. As such, |
| client. | greater than 8%, thus | the transaction is carried out in |
| | burdening the | accordance with the regulations |
| | transaction for the end- | and the cost to end-clients is |
| | client. | drastically reduced. |
| Several | Distortion of prices in | The system organizes similar |
| participants | similar offers. | offers and the deal can only be |
| trading in a | | closed by offering the best |
| decentralized | | price. |
| manner and | End-client spends a lot | The system centralizes offers |
| with | of time and effort doing | from all participants, including |
| different | research. | the end-client within the virtual |
| methods. | | trading environment. |
| Surplus of | Control difficulties by | The origin of the funds and |
| rep- | the Financial | client registration will be |
| resentatives | Institution. | centralized at the FI. The |
| | | Financial Institution's |
| | | representative only sets the |
| | | price for what he wants to sell |
| | | and delivers the foreign |
| | | currency. |
| | Distortion of prices in | The system organizes similar |
| | similar offers. | offers and the deal can only be |
| | | closed with the best price for |
| | | each type of delivery. |
| | Large number of | By centralizing registration and |
| | money laundering | receipt, any attempt at money |
| | attempts. | laundering will be thwarted. |
| Forward | Restriction of potential | The seller can set the selling |
| discount for | operations. | price. The FI purchases it at the |
| the seller and | | price it has set and resells it to |
| end-client. | | the buyer when prices match, |
| | | resulting in a much lower |
| | | brokerage fee to the spread |
| | | than what is currently charged. |
| | Inability to sell the | The seller can set the selling |
| | currency so as to | price. The FI purchases it at the |
| | financially gain from | price it has set and resells it to |
| | the trade. | the buyer when prices match, |
| | | resulting in a much lower |
| | | brokerage fee to the spread |
| | | than what is currently charged. |
| Forward | Inability to sell the | The buyer can set the purchase |
| premium for | currency so as to | price and buy from any |
| the end | financially gain from | participant, including end |
| buyer. | the trade. | sellers. This kind of competition |
| | | reduces the spreads charged. |
| | The increase in the | The buyer can set the purchase |
| | final cost limits travel, | price and buy from any |
| | thereby reducing the | participant, including the end |
| | market as a whole. | seller. This kind of competition |
| | | reduces the spreads charged. |
| Logistics | As the seller keeps the | The seller can sell to the buyer |
| cost | leftover foreign | with the intermediation of a |
| | currency, instead | representative. Since the |
| | of selling it, every | operation is local, there is no |
| | purchase is subject | logistics cost, thus reducing the |
| | to high traditional | overall average cost of the |
| | logistics costs. | transactions. |
| Inability to | In the current model, | As the IF will have |
| buy and sell | in sparsely populated | representatives without money |
| in sparsely | regions, purchase and | inventory, who only validate |
| populated | sale are not viable, | local operations, the |
| regions. | given that the security | maintenance cost is minimal, |
| | investment, money | making it a viable model. |
| | inventory shipping | Moreover, these places tend to |
| | cost, and logistics is | have a higher purchase price, |
| | very high. | as there is a shortage of supply. |
| | | Therefore, clients who travel |
| | | through these regions may buy |
| | | foreign currency in more heavily |
| | | populated municipalities and |
| | | resell in sparsely populated |
| | | regions, making a profit and |
| | | meeting the area's demand. |
| Exchange | They do not present the | The system breaks down the |
| rate seekers | characteristics of each | offer by type of paper currency |
| that | offer | and delivery method, so that all |
| centralize | | offers in the trading |
| offers on | | environment are similar. |
| Internet- | Creates unfair | The system breaks down the |
| based | competition between | offer by type of paper currency |
| systems. | participants. | and delivery method, so that all |
| | | offers in the trading |
| | | environment are similar. Thus, |
| | | the price is the main difference |
| | | between each participant. |
| | Registration and receipt | The FI is responsible for the |
| | of funds are carried out | registration and receipt of |
| | by participant. | funds, reducing the risk of |
| | | participant's compliance. |
| | Prices may fluctuate | After the deal has been closed |
| | between the time the | within the environment, none of |
| | exchange rate is defined | its conditions may be changed. |
| | and the execution of | |
| | the operation. | |
| Software to | According to the | The FI will have a registration |
| connect | standards of the | structure to ensure that |
| sellers and | regulator in most | registered clients really exist |
| end buyers. | countries, including | and can be identified. Upon |
| | Brazil, almost all of | validating the currency, the |
| | these applications are | representative regulates the |
| | illegal. Registration data | operation. |
| | are not checked and | |
| | documentation is not | |
| | requested, thereby | |
| | putting the client at | |
| | risk of being drawn | |
| | into theft or receiving | |
| | counterfeit currency. | |
| | This type of environ- | |
| | ment is conducive | |
| | to money laundering. | |

To achieve the above outlined objectives, a model of its platform capabilities has been developed to create a type of software that would automate and carry out the necessary operations, as shown in FIG. 4, which schematically shows the main operational and relational features of the system, object of this invention.

Description of the Macro Architecture shown in FIG. 5:

The modules will communicate with each other obeying the pre-defined communication interfaces using WCF (REST) model. They will keep in cache the most important data for faster access and in the background they will take care of the storage of data in a non-volatile source (when necessary).

Following are the requirements considered essential and/or relevant to the proper operation of the system, object of the invention, basically defined in four major areas:

General Registrations; Individual Registration and Parameters; Corporate Registration and Parameters, and Negotiations Module (Book, Offers):

### 1. General Registrations

Manage Profiles
Associate Modules
Register Memoranda
Register Regions
Add List of Tradable Assets

### 2. Individual Registration and Parameters

Register Individual (Single)
Send access data
Validate e-mail
Supplementary Registry 01—Individual
Register Individual's Bank Data
Register Individual's Telephone Numbers
Supplementary Registry 02—Individual Registration
Sources of Individual's Income
Register Individual's Equity
Prepare Individual's Statement of Acceptance
Download the Statement of Acceptance
Upload Individual's documents
Validate Supplementary Registry
Manage Individual Registry (View, Edit, Delete)
Calculate Reference Area
Register using Facebook user's data
Register using Linkedin user's data
Register using Google+user's data
Set Global Parameters for Individuals
Set Individual Parameters for Individuals
Check the total number of registrations per IP.
Send New Registration Alert
Reset password/electronic signature
Send proof of deposit
Manage client account. Withdraw money in national currency
Set parameters for trade alerts
Manage Custody
   A new feature never before used in the market, the client may request his currency be transferred to other regions. This operation will have a registered cost set by the FI and will depend on the availability of money inventory in each region.
Manage my offers
Appoint a representative to withdraw the money.
   A new feature never used in the market, the client may appoint a representative to withdraw the money in his behalf. However, the representative must provide the client's registration data.
Manage Global Parameters for Individuals
Manage Individual Parameters for Individuals
Manage documents that are required to be uploaded
Register Addresses

The most relevant of the items listed above are those pertaining to end-clients' custody movement between regions in which the FI or its representatives have a presence. This type of movement makes it possible for the end-client to trade in foreign currency not only his area, but wherever the FI is present, as well as appoint representatives to withdraw the amounts.

In the case of custody movement, the client may request the transfer of his currency to other regions. This function will have a registered cost set by the FI and depend on the availability of money inventory in each region.

The client may appoint representatives who may withdraw his money, which expedites the receipt and delivery of foreign currency. However, the client must provide the registration data of the person responsible for making the withdrawal, maintaining the proper levels of controls.

### 3. Registration and Parameters for a Corporate Entity

Corporate Entity Registration
Set Global Parameters for Corporate Entities
Register Corporate Entity's documents
Upload Corporate Entity's documents
Set Individual Parameters for Corporate Entities
Set Global Parameters for Corporate Entity's Advisers
Set Individual Parameters for Corporate Entity's Advisers
Assign Administrators and Advisers to the Corporate Entity
Validate an Individual as the Corporate Entity's Adviser
View and Edit Advisers linked to the Corporate Entity
Manage Business Days, Hours, and Addresses

### 4. (Book, Offers)

Show book of NEW PAPER CURRENCY IN PERFECT CONDITION
Show book of OLD PAPER CURRENCY IN PERFECT CONDITION
Show trash book
   The in-cash foreign exchange market has never been organized in a virtual trading environment, whereby the foreign currency of each participant is classified by the physical state and generation of the paper currency, thus changing a single currency, the dollar, for example. In this system, for the currency to be traded, it will be classified into two or more homogeneous assets. U.S. dollar—new paper currency in perfect condition; U.S. dollar—old paper currency in perfect condition, or U.S. dollar—damaged paper currency. In addition to the innovative creation of a virtual trading environment for tourist exchange, it created a method that breaks down each form of currency into:
      new paper currency in perfect condition,
      old paper currency in perfect condition, or
      damaged paper currency.

### Virtual Trading Environment

In the in-cash foreign exchange market for clients, offers in the same currency made by different participants were never organized in a virtual trading environment.

In addition to the innovative creation of a virtual trading environment for in-cash currency exchange, it created a method that breaks down each form of currency into:
new paper currency in perfect condition,
old paper currency In perfect condition, or
damaged paper currency.
   FIGS. 5A, 5B, and 5C illustrate a possible embodiment in this environment.

### Final Price Calculation of the Offer for Buyer/Seller

The innovation consists of calculating the T.E.0 (total effective cost) to the client, using the desired amount, so as to spread the fixed cost (if any) for the offer to be ordered at the best price.

### Place Orders in the Offers Book

The innovation lies in the fact that the offerings are arranged at the best price, both in sales and purchase, which never happened before in the in-cash foreign exchange market.

The best offers for each type of delivery will have priority in closing deals with respect to similar offers with the worst prices.

In any registered offering, the best price will be highlighted or listed in the first position in the order book, both for the purchase and sale. This means the best price for the purchase is the highest price and the best price for the sale is the lowest price. If there are two offers at the same price, the priority sequence is:
1. Better rating (within the same category of the offering party, the better the rating, the higher the priority).
2. If the above rules are equal, priority will be given to the offer that was submitted first.

Unlike the Stock Exchange, whose criterion is to use the best offer to close the deal, in the Trading System, object of this invention, the best offer for each type of delivery can be used to close the deal. However, if the best offer of delivery involving a face-to-face meeting between two end-customers has a higher price than delivery in which the client withdraws the foreign currency from a branch office or exchange currency representative of the FI, then, in this case, the offer of delivery in person cannot close the deal.
Display Online Exchange Rate Panel
Set Global Trading Parameters
Issue Purchase Slip
Issue Selling Slip
Export transactions (synchronize with Exchange)
Reflect SELLING Offers
   The selling offer may be made in several regions in which the client is willing to deliver the currency. This is an innovation, since the system uses the physical points (exchange currency representatives and branch offices) to identify the clients who may see the offer.
   Once the deal is closed, the system not only tells the seller the exact location for the delivery of foreign currency, but also tells the buyer where he can pick up the currency.
To Close the Deal at a Given Price
To Match Offers
   Once the conditions to close the deal have been confirmed, the system automatically closes the operation, thus making it impossible to change the price and for any party to back out.
Confirm that Orders Match
Prepare an Agreement for the client and report the transaction to the country's Exchange Market Regulator (this is required of most countries that do not have a strong currency, such as Brazil, in which case the FI must inform BACEN on such transactions).
Prepare an interbank Agreement and inform the Exchange Market Regulator about the operation.
   The interbank Agreement is needed when a certain financial institution that is a partner and makes an offer within the trading environment closes a transaction with the end-client in the System, object of this invention.
   This is another innovation because, currently, the financial institutions authorized to operate in the foreign exchange market are responsible for client registration, the “know your customer” (KYC) policy, and checking the source of funds that will allow the operation, according to the regulator's guidelines, thus resulting in excessive costs and inefficient control, often impeding operations or making them extremely expensive for the end-client.

The In-Cash Foreign Currency Trading system centralizes the registration of all end-clients, implements the “know your client” policy, and checks the origin of the funds. Thus, when the operation is carried out by the selling party, such as a financial institution that trades in the system, the FI, which is behind the system, buys from this financial institution through an operation on the interbank market and resells to the end-client in the primary market. In this model, the financial institution partner does not have to worry about registering the end-client, implementing the “know your customer” policy, and checking the origin of the funds to carry out the operation.
Give notice of closing a deal by e-mail.
Manage Global Delivery Options
Show Summary of Delivery Options
Manage Delivery Costs for OPERATORS
Include Purchase Offer
Set up Order with Indexed Price

With the indexed price, any participant can send an order based on the price of the commercial or the official exchange rate of the currency. Thus, the participant can close deals automatically without the need for full-time follow-up.
Set up Order with Price based on the amount.
   New feature to make things easier for the participants.
   Participating FIs, their branch offices, and representatives can register different prices for the total amount of each deal to be carried out.

### EXAMPLE

A financial institution that trades in the System registers an offer stating that it sells U.S. $100,000 under the following conditions:

<500 dollars=3.45

<1000 dollars=3.42

<3000 dollars=3.40

<5000 dollars=3.39

>5000 dollars=3.37

Or

<500 dollars=commercial+4%

<1000 dollars=commercial+3.7%

<3000 dollars=commercial+3.3%

<5000 dollars=commercial+3.1%

<5000 dollars=commercial+2.8%
Set the BUYER′S Delivery Options

The buyer can choose to filter the type of delivery he wants. The table of offers presents only the deliveries in which the buyer is interested.
Specify the PURCHASE Offer
Enter the PURCHASE Order
   When a purchase order has been entered, the client can choose the total amount, the minimum amount he wants to buy per closed order and, moreover, the price at which to close the deal. The chosen price may or may not close the deal immediately. If the transaction is not closed immediately, the other market participants can see the offer and its features so as to negotiate it. This creates transparency and helps to set the price of the in-cash currency market.
Show the Book of Offers to the Buyer
   The Book of Offers only shows the offers that meet the purchaser's desired amounts and may hide other offers, depending on the filters selected by said buyer.
Show the best offers to the Buyer
   This function selects the best offers of each type of delivery for the buyer, showing them in a simple, intuitive way so as to increase the System's usability.
Confirm Purchase Order
Include Selling offer
Register Paper Currency Not Held in Bank Custody
   The seller that does not leave his foreign currency in the custody of a branch office or an exchange currency representative of the FI which, in turn, will be behind the system, can register the paper currency he wants to offer. To do this, he has to send a percentage of the amount he wants to sell in local currency to the drawing account(s) of the FI, which is behind the system, or register a financial guarantee, for example, a pre-authorization to charge his credit card. Thus, the system remains safe for all participants.
Set up the Indexed Price
   The indexed price allows any participant to send an order with the price based on the value of the commercial exchange rate or the official rate of the foreign currency set by the Exchange Market Regulator. Thus, the participant can automatically close deals or change the price of the trade.
Specify the Selling Offer
Enter the Selling Order
Show the Book of Trade Deals to the Seller
Confirm the Selling Order
Show the numbers of the offers
Select Places and Times for C2C Validation
Confirm Place, Day, and Time for C2C Validation
   The C2C operation is an innovation because, with it, so as to maintain legality, it created the figure of a currency exchange representative, who has no currency inventory, but enters the transaction to buy from the seller-client and resells to the buyer-client.
   As this representative does not need a currency inventory, it can be any person or corporate entity, provided that an exchange representative agreement is signed with the FI behind the system. Thus, the representative has a chance to earn substantial additional income in addition to allowing the end-client to carry out the operations legally.
Upload Over-the-Limit Agreement
Digitally Sign Over-the-Limit Agreement
Check the Operator's qualifications
Qualify the Operator
   With the System, the parties involved in a particular trade can qualify each other. However, although it is very common in today's market, this qualification can be considered an innovation, since, in the System, qualification is one of the factors used to set the priority of similar offers. In other words, if two offers have similar conditions (price, type of delivery, or type of paper currency), the participant who has better qualifications is given priority.
Issue Direct Trade slip
Show Book of Offers with the Financial Result of the Operation
   Representatives, branch offices, and FI partners, based on the cost that they themselves registered, will have direct access to the financial result of the operation, which enables them to determine whether or not the operation is viable in a matter of seconds.
Simulate the Financial Result of the Operation
   The system provides a calculator for participants, which shows only the final price, amount, financial results, and the percentage of the operation.
Show the Competition on the Same Offer
Show Pending C2C Validations

### Confirm Validation of C2C Currency

C2C is the operation through which two clients are intermediated and monitored by a validation representative.
This validation is done in the system. The representative that evaluates the operation is supposed to state whether the operation was carried out or has been totally or partially completed.
Carry Out the C2C Operation with Validation
   After the operation has been carried out, the information is sent to the regulator.
Solve Any Pending Issues, Penalizing the C2C Buyer
Solve Any Pending Issues, Penalizing the C2C Seller
Identify Place, Day, and Time for C2C Validation
Validate C2C Operation
Manage Pre-slips

### 5. Custody and Financial Module

Set global custody and financial parameters
Register payment methods
Register custody management fees
Register monthly custody fee
Calculate simple trading limit
Calculate advanced trading limit
Calculate accumulated trading limit
Calculate maximum limit for the sale of currency not held in custody
Calculate available financial balance
Calculate foreign currency custody
Block custody of currency being traded in the market
Update financial balance
Update custody
   As soon as a particular seller client sends an offer to sell, the system blocks the amount to prevent the client from making two offers with the same currency. When the sale is successfully completed, the money is withdrawn from the client's custody.
Debit the Financial Balance
   When the purchase is carried out, the funds, object of the transaction, are charged to the buyer client's account in the system.
Credit Paper Currency Held in Custody
   When the seller-client deposits the currency he intends to offer with an exchange representative or in a branch office, the client's custody in the system is credited so the client can make the offer.
Send Alert of Completed Transaction
Debit Paper Currency Held in Custody
   When the sale is successfully carried out, the money is withdrawn from the seller client's custody.
Credit the financial balance
   When the sale is considered complete, the funds, object of the sale, are credited to the seller client's account in the system.
Add pending issues to the C2C SELLER
Add pending issues to the C2C SELLER
Add pending issues to the C2C BUYER
Send alert of transaction pending validation
   Block financial balance
   This happens when a particular offering is sent to the system. If the client does not have custody in an accredited branch office or with a representative, the financial amount is blocked to ensure full compliance of the transaction.
Send notification that funds have been sent
Remove pending issues from the C2C SELLER
Remove pending issues from the C2C BUYER
Manage client penalties
Upgrade client ranking (buyer/seller)
Debit the fine from the client's financial balance or guaranty.
   To ensure that participants comply with the deals closed in the system, said participants have to send the funds in the national currency or guarantees, for example, the credit card number for pre-authorize the charge to the drawing account(s) of the FI, which is behind the system. In the event one party backs out of the deal, the delivery of counterfeit currency, or paper currency that deviates from the registered currency, or any other offense, a fine will be debited from the financial balance of the client who violated the system's terms and conditions so as to financially compensate the party that was encumbered and the FI, which is behind the system.
Credit the financial amount to the client that was encumbered.
   When a participant is encumbered by the action of another participant, outside the system's terms and conditions, said participant shall be indemnified so as not to suffer any loss. The compensation will be credited to the client's account in the system, in national currency.
      Reverse client fine
Confirm delivery of C2C currency
Confirm receipt of C2C currency
Confirm delivery of foreign currency
Show the total amount of currency pending delivery
Confirm receipt of client's custody
Upload photo of paper currency
Report impediment of counterfeit currency
Report impediment of discrepancies in the offer
Confirm acceptance of discrepancy
Adjust amounts in the agreement
Calculate the sale price of different paper currencies
Show foreign currency inventory (complete)
   In addition to having foreign currency inventory available for sale, the system will allow accredited seller clients to deposit the currency they wish to offer with an exchange representative or at a branch office.
Show foreign currency inventory (summary)
Show foreign currency custody (complete)
Send notification that funds have been sent
Upload proof of receipt of funds that have been sent
Request foreign currency inventory
Show financial balance (summary)
Show financial statement (complete)
Control deliveries
Manage operator's trading costs
Manage declared foreign currency inventory
Validate receipt of funds
Validate advanced trading limit

### 6. General Module

Set up phantom trading robot
Register disclaimers (notices)
Manage clients' custody
Manage the movement of foreign currency inventory
Manage banks in sending and receiving funds
Manage the system's trading costs
Calculate PIS
Calculate COFINS
Calculate CSLL
Export to Excel
Link transaction costs to profile
Send e-mail
Show disclaimers
Send text message

### 7. Security and Monitoring Modules

Send alert of attempted fraud
Send alert of attempted hacking
Account for access to database
Check permission to access modules
Log-in
Monitor registrations
Monitor new partners
Monitor PLD and compliance risks
Generate report of suspected counterfeit paper currency
Check CPF at the Federal Revenue
Generate report on delivery problems
Generate profile reports on social networks
Generate report on the cancellation of unpaid balance
Generate report on the cancellation of orders per client
Generate reports of attempts to register an inactive CPF or one belonging to a deceased individual
Generate IP control report
Generate report of clients that made withdrawals for other clients
Register Log
Block purchase and sale

### 8. Routines and Integration

Update foreign currency reference values
Integrate Anywhere chat
Integrate Anywhere push.

1. “AN IN-CASH FOREIGN CURRENCY TRADING SYSTEM”, a virtual environment developed to bring all participants together in the in-cash foreign currency market such as end buyers, end sellers, and other financial institutions operating in the foreign exchange market, in addition to exchange currency representatives, and the offices of the Financial Institution that carries out the registration and the receipt of funds, characterized by the fact that the virtual trading environment, created through a software platform, automates and carries out the necessary operations, organizes similar offerings and breaks them down by type of paper currency and delivery method, centralizing all participants' offers, including end-clients. It also organizes similar offerings so that only the deals involving the best offers in each segment can be closed and the conditions cannot be changed after closing the deal on the platform, thereby protecting the participants against future currency fluctuations or from one of the party's backing out, thereby enabling the parties to close whatever transactions they conduct with each other. Said software comprises four main modules: General Registrations; Individual Registration and Parameters; Corporate Registration and Parameters, and Negotiations Module and yet, a Custody and Financial Module, General Module, Security and Monitoring Modules and Routines and Integration Module.

2. “AN IN-CASH FOREIGN CURRENCY TRADING SYSTEM” as per claim 1, characterized by the fact that it generates a guarantee of transactions and promotes the mandatory sending of funds in national currency or a credit card number to the drawing account (s) of the IF, which is behind the system, to allow a pre-authorization of the charge.

3. “AN IN-CASH FOREIGN CURRENCY TRADING SYSTEM” as per claim 1, characterized by the fact that the Financial Institution be authorized to operate by the authority responsible for exchange control, acting as a counterparty in all transactions, collecting and validating the required information and informing the regulator of all completed transactions, thus enabling all participants to negotiate freely, including buyers and sellers—end-clients.

4. “AN IN-CASH FOREIGN CURRENCY TRADING SYSTEM” as per claim 1, characterized by the fact that it allows a participant to act as an “arbitrator between regions” in sparsely populated areas, and also the existence of the validation representatives or validators that are intermediate agents of a financial institution authorized to operate in the exchange market to receive the parties that have closed trading on the platform and prove that the currency is genuine and that they comply with the seller's statements so as to pass them on to the buyer.

5. “AN IN-CASH FOREIGN CURRENCY TRADING SYSTEM” as per claim 1, characterized by the fact that the seller can set the selling price and the FI purchases it at the price it has set and resells it to the buyer when prices match, resulting in a much lower brokerage fee to the spread than what is currently charged. Alternatively, the seller can sell to the buyer with the intermediation of a representative.

6. “AN IN-CASH FOREIGN CURRENCY TRADING SYSTEM” as per claim 1, characterized by the fact that the buyer can set the purchase price and buy from any participant, including end-sellers.

7. “AN IN-CASH FOREIGN CURRENCY TRADING SYSTEM” as per claim 1, characterized by the fact that the General Registration module is responsible for Manage Profiles, Associate Modules, Register Memoranda, Register Regions and Add List of Tradable Assets.

8. “AN IN-CASH FOREIGN CURRENCY TRADING SYSTEM” as per claim 1, characterized by the fact that the Registration and Parameters for Individuals is responsible for Register Individual (Single), Send access data, Validate e-mail, Supplementary Registry 01—Individual, Register Individual's Bank Data, Register Individual's Telephone Numbers, Supplementary Registry 02—Individual Registration, Sources of Individual's Income, Register Individual's Equity, Prepare Individual's Statement of Acceptance, Download the Statement of Acceptance, Upload Individual's documents, Validate Supplementary Registry, Manage Individual Registry (View, Edit, Delete), Calculate Reference Area, Register using Facebook user's data, Register using Linkedin user's data, Register using Google+ user's data, Set Global Parameters for Individuals, Set Individual Parameters for Individuals, Check the total number of registrations per IP, Send New Registration Alert, Reset password/electronic signature, Send proof of deposit, Manage client account. Withdraw money in national currency, Set parameters for trade alerts, Manage Custody, Manage my offers, Appoint a representative to withdraw the money, Manage Global Parameters for Individuals, Manage Individual Parameters for Individuals, Manage documents that are required to be uploaded, Register Addresses.

9. “AN IN-CASH FOREIGN CURRENCY TRADING SYSTEM” as per claim 1, characterized by the fact that Registration and Parameters for a Corporate Entity Module is responsible for Corporate Entity Registration, Set Global Parameters for Corporate Entities, Register Corporate Entity's documents, Upload Corporate Entity's documents, Set Individual Parameters for Corporate Entities, Set Global Parameters for Corporate Entity's Advisers, Set Individual Parameters for Corporate Entity's Advisers, Assign Administrators and Advisers to the Corporate Entity, Validate an Individual as the Corporate Entity's Adviser, View and Edit Advisers linked to the Corporate Entity, Manage Business Days, Hours, and Addresses.

10. “AN IN-CASH FOREIGN CURRENCY TRADING SYSTEM” as per claim 1, characterized by the fact that that the Trading module is responsible for Show book of NEW PAPER CURRENCY IN PERFECT CONDITION, Show book of OLD PAPER CURRENCY IN PERFECT CONDITION, Show trash book, Display Online Exchange Rate Panel, Set Global Trading Parameters, Issue Purchase Slip, Issue Selling Slip, Export transactions (synchronize with Exchange), Reflect SELLING Offers, To Close the Deal at a Given Price, To Match Offers, Confirm that Orders Match, Prepare an Agreement for the client and report the transaction to the country's Exchange Market Regulator, Prepare an interbank Agreement and inform the Exchange Market Regulator about the operation, Give notice of closing a deal by e-mail, Manage Global Delivery Options, Show Summary of Delivery Options, Manage Delivery Costs for OPERATORS, Include Purchase Offer, Set up Order with Indexed Price, Set up Order with Price based on the amount, Set the BUYER′S Delivery Options, Specify the PURCHASE Offer, Enter the PURCHASE Order, Show the Book of Offers to the Buyer, Show the best offers to the Buyer, Confirm Purchase Order, Include Selling offer, Register Paper Currency Not Held in Bank Custody, Set up the Indexed Price, Specify the Selling Offer, Enter the Selling Order, Show the Book of Trade Deals to the Seller, Confirm the Selling Order, Show the numbers of the offers, Select Places and Times for C2C Validation, Confirm Place, Day, and Time for C2C Validation, Upload Over-the-Limit Agreement, Digitally Sign Over-the-Limit Agreement, Check the Operator's qualifications, Qualify the Operator, Issue Direct Trade slip, Show Book of Offers with the Financial Result of the Operation, Simulate the Financial Result of the Operation, Show the Competition on the Same Offer, Show Pending C2C Validations, Confirm Validation of C2C Currency, Carry Out the C2C Operation with Validation, after the operation has been carried out, the information is sent to the regulator, Solve Any Pending Issues, Penalizing the C2C BUYER, Solve Any Pending Issues, Penalizing the C2C SELLER, Identify Place, Day, and Time for C2C Validation, Validate C2C Operation, Manage Pre-slips.

11. “AN IN-CASH FOREIGN CURRENCY TRADING SYSTEM” as per claim 1, characterized by the fact that the System breaks down each form of currency into new paper currency in perfect condition, old paper currency in perfect condition, and damaged paper currency.
